(19) United States
(12) Patent Application Publication
(10) Pub. No.: US 2006/0187594 A1
(43) Pub. Date: Aug. 24, 2006

(54) DC ground fault circuit interrupter

(76) Inventor: Nicholas L. DiSalvo, Levittown, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/342,960

(22) Filed: Jan. 30, 2006

Related U.S. Application Data
(60) Provisional application No. 60/648,860, filed on Jan. 28, 2005.

(51) Int. Cl. H02H 3/00

(52) U.S. Cl. 361/42

(57) ABSTRACT

A ground fault circuit interrupter for a direct current (DC) system which can interrupt DC power connections to one or more loads when a fault is detected is disclosed herein. Specifically, the circuit interrupter includes a toroidal core having a winding wound around the core. An alternating current supply is coupled to the current sense winding. Source and return wires of an external DC current supply pass through the core, coupling the DC current supply to respective ends of an external DC load. A current imbalance between the source and return wires causes the core to saturate changing the impedance of the winding. The impedance change causes a fault signal to be generated and said fault signal is used to break the electrical connection between the external direct current supply and the external load.

Under 35 U.S.C. 119(e), this application claims the benefit of the filing date of a provisional application having Ser. No. 60/648,860 which was filed on Jan. 28, 2005.

### FIELD OF THE INVENTION

The present invention relates to a ground fault circuit interrupter, in general and to a direct current (DC) ground fault circuit interrupter, in particular.

### BACKGROUND OF THE INVENTION

A ground fault circuit interrupter (GFCI) is a device that is capable of detecting abnormal current flow in an electrical system and, consequently, interrupt power to the electrical system in which the fault occurred. In such a manner the device can protect persons from electric shock and fire. In the absence of a ground fault, the GFCI can enable connection of power to the GFCI itself and to downstream electrical loads. When a ground fault is detected, the GFCI can open contacts to disconnect the power to the electrical loads. GFCIs are common in alternating current (AC) systems including those in households. When a ground fault is detected, a GFCI can interrupt both phase and neutral lines.

In direct current (DC) systems, a DC control power system is generally utilized within power generating plants and includes numerous batteries connected to provide two DC sources of opposite polarity relative to ground, such as, +125 volts and −125 volts. These sources must be maintained in a fully charged condition, since hundreds of devices feed from the power supplied through a large number of buses over hundreds of miles of cable. If there is a failure of insulation between the applied potential and ground with respect to any device, however, a ground current flow will result. Similarly, if a failure of insulation occurs between the opposite polarity and ground, a short circuit across the full power supply could eventually evolve. The integrity of the power supply is critical since the entire power of the plant relies upon the DC power source supply.

Presently, there are DC fault detectors including fault notification mechanisms where the detector merely indicates that a fault exists. These devices, however, do not isolate the fault. The procedure to isolate a fault often involves manual isolation of the system buses and feeds individually until the cable or device that has an insulation failure is determined.

One approach towards isolating a DC ground fault includes placing a DC ground fault detector on each cable or group of cables that feed a portion of the plant control power system. This approach enables rapid detection which reduces the time of exposure of the system to a potential second ground fault of opposite polarity. In reference to expense, this approach must be implemented economically. Furthermore, the DC fault detector must be reliable and easy to install.

A known fault detector, as taught in U.S. Pat. No. 4,371,832 which is incorporated herein by reference, includes a high permeability toroidal core (or the like) having a square hysteresis loop. There are three windings wound about the toroid in a solenoidal configuration. Two of the three windings have an equal number of turns and, when energized, have an electric current flow therethrough such that the magnetomotive force within the toroidal core because of one of the two windings opposes (i.e., bucks) the magnetomotive force within the toroidal core because of the other of the two windings. The two windings, in an operating system, are connected in series with a load to be monitored, the load being connected serially between the two windings. A difference between the currents in the two windings shows the existence of a ground fault, the difference being the ground current at the fault. Sensing means is provided to note any such difference in electric current flow in the two windings. The sensing means includes a voltage source and series resistor connected across the third of the three windings; the polarity of the voltage applied by the voltage source to the third winding and series resistor is reversed every time the current in the third winding reaches a predetermined amplitude. Means is provided to determine the duty cycle of the voltage applied to the third winding and to relate that duty cycle to any fault current in the portion of the system supplied through the aforementioned two windings.

The sensing means and the means provided to determine the duty cycle of the voltage applied to the third winding, however, are complex and thereby not economical. Furthermore, the DC fault detector taught in this reference does not interrupt the power provided in the circuit connecting the DC source to the DC load. This approach merely detects a fault but does not disable the power supplied to the DC load from the DC source.

Thus, a need exists for a DC fault circuit interrupter that is simple, economical and easy to install.

The present invention is directed to overcoming, or at least reducing the effects of one or more of the problems set forth above.

### SUMMARY OF THE INVENTION

To address the above-discussed deficiencies of DC ground fault detectors, the present invention teaches a DC ground fault circuit interrupter having a simple and economic design. A ground fault circuit interrupter for a direct current (DC) system which can interrupt the DC power when a fault is detected along with a method for detecting a ground fault in a DC system and interrupting the circuit are disclosed herein. Specifically, the DC fault interrupter in accordance with the present invention includes a toroidal core having a winding wound around the core. An alternating current (AC) supply is coupled to the winding. A source wire and a return wire of an external DC current supply pass through the core and couple the supply to respective ends of an external DC load. A current imbalance detector provides a fault signal in response to the existence of a current imbalance between the source and return wires. The frequency of the alternating current applied to the winding is substantially constant. A circuit interrupter is configured to break the electrical connection between the external direct current supply and the external load in response to the occurrence of a predetermined condition.

In an alternative embodiment, a conditioning and control circuit receives the fault signal from the current imbalance detector and generates a signal to energize a trip solenoid which trips the circuit connecting the DC current supply to the external DC load by opening switches connected to the source wire and the return wire. In either implementation, the AC supply may be derived from the DC supply.

The method in accordance with the present invention includes, in a first step, a source wire and a return wire are passed through a toroidal core having a current sense winding. In another step, the winding is coupled to an alternating current supply having a frequency that is substantially constant. The source and return wires are coupled to an external direct current supply and an external load in another step. The AC current in the winding is chosen such that a current imbalance between the source and return wires saturates the core. The saturation of the core changes the impedance of the winding. A current imbalance is thus detected between a level of current in the source wire and the level of current in the return wire by monitoring the impedance of the winding. In another step, a fault signal is generated when the detected current imbalance exceeds a particular level defined by a manufacturer or industrial/governmental entity, wherein the frequency of the alternating current is substantially constant.

The defined level is determined by using a comparator that reacts to the saturation of the core. One of the inputs to the comparator is connected directly or indirectly to the winding. Because the impedance of the winding changes due to the saturation of the core, the value of the signal at the one input changes sufficiently to cause the comparator to change state.

Advantages of this design include but are not limited to a simple, economical ground fault circuit interrupter that can detect a ground fault without monitoring the frequency shift in the AC supply.

These and other features and advantages of the present invention will be understood upon consideration of the following detailed description of the invention and the accompanying drawings.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 displays a flow chart of a method for a direct current ground fault circuit interrupter in accordance with to the present invention.

FIG. 2 illustrates a schematic of a direct current ground fault circuit interrupter in accordance with to the present invention.

### DETAILED DESCRIPTION OF PREFERRED EMBODIMENTS

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

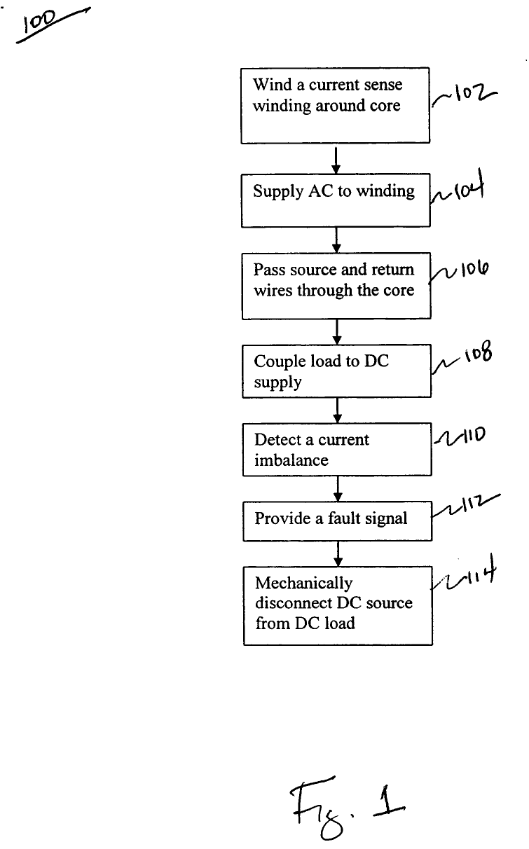

FIG. 1 represents a flow chart 100 of an implementation of a direct current (DC) ground fault circuit interrupter (GFCI). In step 102 a current sense winding is wound around a toroidal core. The core may be selected to saturate at a desired magnetic field. In step 104, alternating current (AC) can be supplied to the current sense winding. In step 106, a source wire and a return wire pass through the toroidal core and, in step 108 connect an external DC supply to an external DC load. Current from the supply flows through the source wire to the load and returns to the supply through the return wire. The AC current level is chosen such a sufficient DC current imbalance between the source and return wires causes the core to saturate which changes the impedance of the winging. In step 110, a current imbalance detector can detect 110 a current change due to a desired level of impedance change in the winding 206 and in step 112 provide a fault signal that can be used to disconnect the DC supply from the load. Finally in step 114, the DC source is mechanically disconnected from the DC load in step 114.

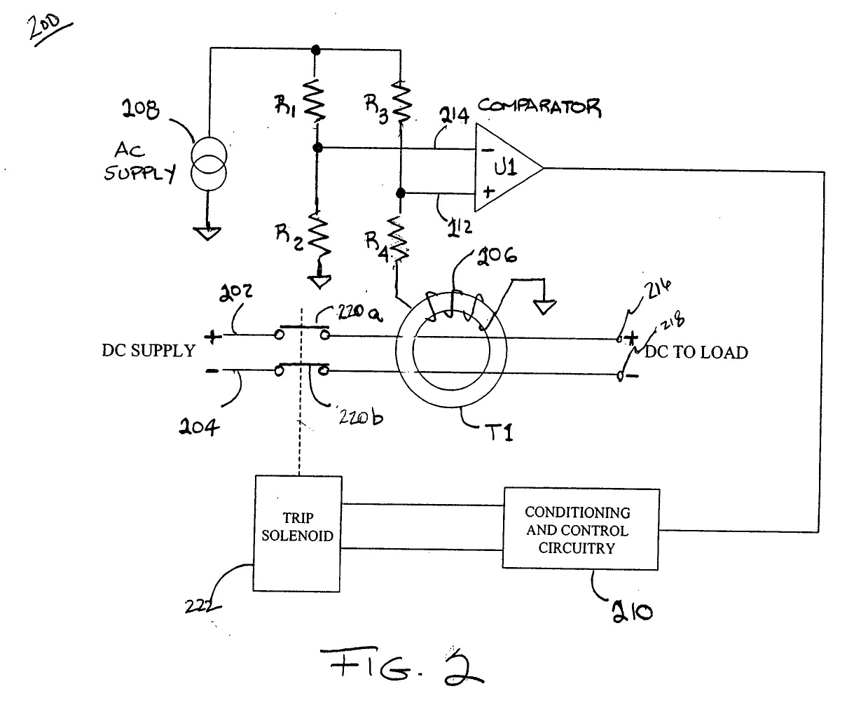

FIG. 2 illustrates an implementation of a DC ground fault circuit interrupter in accordance with the present invention. A positive (+) source wire 202 and a negative (−) return wire 204 are coupled to respective terminals of an external DC supply (not shown and not part of the invention). Supply contact terminals such as screw terminals may be provided on the GFCI to facilitate coupling of a first end of the source and return wires to the DC supply. The respective source and return wires, 202 and 204, can be coupled to contacts 220a, 220b of trip solenoid 222. The source and return wires, 202 and 204, can pass through a toroidal core of a transformer T1 and then be coupled to respective ends of a load, 216 and 218. Load contact terminals, 216 and 218, such as screw terminals may be provided on the GFCI to facilitate coupling of a second end of the source and return wires to the load. A winding 206 is wound on the toroidal core T1.

A current imbalance detector detects a change in current through the use of winding 206. The current imbalance detector includes an alternating current (AC) supply 208 that connects to a first voltage divider comprising resistors, R3 and R4, and winding 206 connected in series to ground. A junction point between resistors, R3 and R4, provide a first input 212 to a comparator U1. The AC supply 208 is also connected to a second voltage divider that includes resistors, R1 and R2, connected in series. The junction between resistors, R1 and R2, provide a second input 214 to comparator U1. The comparator compares the signal levels at its inputs 212 214 and outputs a voltage depending on the relative levels. The output of comparator U1 is connected to circuitry 210 for conditioning and controlling the output of the comparator U1. Conditioning and Control circuitry 210 energizes a solenoid 222 in response to an output from the comparator U1.

The conditioning and control circuitry 210 also may include circuitry to add features to a DC GFCI. The circuitry 210 may include features such as a test button to test the working of the GFCI and a reset button to reset the GFCI after a fault has been detected and cleared. The circuitry 210 also may including a electrical or mechanical latching system to latch the trip solenoid when a fault is detected. Additional circuitry may include features such as automatic and periodic self-testing of the GFCI and/or communication circuitry for transmitting and/or receiving signals to/from a remote location. The DC GFCI 200 herein described may be mounted in a standard single-gang receptacle outlet box.

When in use, the first end of the source and return wires 202, 204 are coupled to an external DC supply and the second ends of the source and return wires are coupled to an external load. The source and return wires, 202 and 204, pass through the toroidal core T1. Current flows from the DC supply through the source wire 202 to the load and returns to the DC supply through the return wire 204. Under normal conditions, the current in the source wire 202 is substantially the same as, or balances, the current in the return wire 204. A leakage of current on the load side of the GFCI can cause an imbalance in the level of current in the source and return wires, 202 and 204. The imbalance in the DC load currents gives rise to a magnetic field in transformer T1. Transformer T1 may be chosen so that the toroidal core of the transformer saturates at a desired level of DC imbalance between the source and return wires, 202 and 204. When transformer T1 saturates, the impedance of the winding 206 is caused to change, which, in turn, can cause a shift in the signal level of one of the inputs 212 of comparator U1. When the signal level at the first input 212 exceeds a defined level at the first input 214, the comparator U1 output changes state to provide a fault signal to the conditioning and control circuitry 210. The conditioning and control circuitry 210 may include noise immunity circuitry to add desired levels of reduction in false triggering and interruption and, also, drive circuitry to provide current drive as required for the trip solenoid 222. The fault signal can cause the conditioning and control circuitry 210 to energize the trip solenoid 222, which, in response, opens the contacts, 220a and 220b, to disconnect DC power from the load, effectively interrupting the power supplied to the load.

Those of skill in the art will recognize that the physical location of the elements illustrated in FIG. 2 can be moved or relocated while retaining the function described above. For example, the voltage divider arrangement including resistors R1, R2, R3 and R4 may be designed differently, yet produce the same function.

Advantages of this design include but are not limited to a DC ground fault circuit interrupter having a high performance, simple, and cost effective design.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

We claim:

1. A direct current (DC) ground fault circuit interrupter comprising:
a toroidal core;
a current sense winding wound around the core;
an alternating current supply coupled to the current sense winding, wherein the frequency of the alternating current supply is substantially constant;
a source wire and a return wire passing through the core for coupling an external direct current supply to respective ends of an external load; and
a current imbalance detector to provide a fault signal in response to a current induced in the current sense winding in response to a difference between the current in the source wire and the return wire; and
a circuit interrupter configured to break the electrical connection between the external direct current supply and the external load in response to the occurrence of a predetermined condition.

2. The direct current (DC) ground fault circuit interrupter of claim 1 further comprising:
a conditioning and control circuit connected to the current imbalance detector to receive the fault signal and to provide noise immunity and drive circuitry.

3. The direct current (DC) ground fault circuit interrupter of claim 1, wherein the circuit interrupter comprising:
a pair of switches, wherein a respective one of the pair of switches is disposed within the source wire and a return wire; and
a trip solenoid coupled between the pair of switches and the conditioning and control circuit to decouple at least one of the source wire and the return wire from the direct current supply.

4. The direct current (DC) ground fault circuit interrupter of claim 1, wherein the alternating current supply is derived from the direct current supply.

5. The direct current (DC) ground fault circuit interrupter of claim 4, wherein the alternating current supply has a desired frequency and wave shape.

6. A method of detecting an electrical fault comprising:
passing a source wire and a return wire through a toroidal core having a current sense winding;
coupling the current sense winding to an alternating current supply, wherein the frequency of the alternating current supply is substantially constant
coupling the source and return wires to an external direct current supply and an external load;
detecting a current imbalance between a level of current in the source wire and the level of current in the return wire;
providing a fault signal when the detected current imbalance exceeds a predetermined level; and
interrupting the connection between the external direct current supply and the external load in response to a fault signal.

7. The method of claim 6, further comprising the steps of:
conditioning and controlling the fault signal to provide noise immunity and drive capability.

8. The method of claim 6, wherein the alternating current supply is derived from the direct current supply.

9. The method of claim 8, wherein the alternating current supply has a desired frequency and wave shape.
